(19) United States
(12) Patent Application Publication
(10) Pub. No.: US 2023/0141660 A1
(43) Pub. Date: May 11, 2023

(54) TERMINAL, RADIO COMMUNICATION METHOD, AND BASE STATION

(71) Applicant: NTT DOCOMO, INC., Tokyo (JP)

(72) Inventors: Yuki Matsumura, Tokyo (JP); Hiroki Harada, Tokyo (JP); Satoshi Nagata, Tokyo (JP)

(73) Assignee: NTT DOCOMO, INC., Tokyo (JP)

(21) Appl. No.: 17/911,885

(22) PCT Filed: Mar. 19, 2020
(86) PCT No.: PCT/JP2020/012420

§ 371 Date: Sep. 15, 2022

(51) Int. Cl. H04W 72/23; H04W 72/1273; H04L 5/00

(52) U.S. Cl. CPC H04W 72/23; H04W 72/1273; H04L 5/001

(57) ABSTRACT

A terminal according to one aspect of the present disclosure includes a receiving section that receives downlink control information (DCI), and a control section that, when one piece of the DCI simultaneously schedules PDSCHs respectively transmitted on a plurality of component carriers (CCs), applies a TCI state based on a common rule to the PDSCHs. According to one aspect of the present disclosure, it is possible to apply an appropriate TCI state to a PDSCH.

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement and the like of the LTE (Third Generation Partnership Project (3GPP) Release (Rel.) 8 and Rel. 9), the specifications of LTE-Advanced (3GPP Rel. 10 to Rel. 14) have been drafted.

Successor systems of LTE (for example, also referred to as “5th generation mobile communication system (5G),” “5G+(plus),” “6th generation mobile communication system (6G),” “New Radio (NR),” “3GPP Rel. 15 (or later versions),” and so on) are also under study.

In existing LTE systems (for example, 3GPP Rel. 8 to Rel. 14), a user terminal (User Equipment (UE)) transmits uplink control information (UCI) by using at least one of a UL data channel (for example, a Physical Uplink Shared Channel (PUSCH)) and a UL control channel (for example, a Physical Uplink Control Channel (PUCCH)).

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

For future radio communication systems (for example, NR), one piece of Downlink Control Information (DCI) to simultaneously schedule PDSCHs respectively transmitted on a plurality of Component Carriers (CCs) is under study.

However, when one piece of DCI simultaneously schedules Physical Downlink Shared Channels (PDSCHs) respectively transmitted on a plurality of CCs, how to configure a TCI state applied on each CC is an issue. Unless the TCI state applied on each CC is configured appropriately, communication quality may deteriorate.

Thus, an object of the present disclosure is to provide a terminal, a radio communication method, and a base station that can apply an appropriate TCI state to a PDSCH.

### Solution to Problem

A terminal according to one aspect of the present disclosure includes: a receiving section that receives downlink control information (DCI); and a control section that, when one piece of the DCI simultaneously schedules PDSCHs respectively transmitted on a plurality of component carriers (CCs), applies a TCI state based on a common rule to the PDSCHs.

### Advantageous Effects of Invention

According to one aspect of the present disclosure, it is possible to apply an appropriate TCI state to a PDSCH.

### BRIEF DESCRIPTION OF DRAWINGS

FIG. 1 is a diagram to show an example of TCI control by DCI;

FIG. 2 is a diagram to show an example of TCI control in a case where scheduling offset is less than a threshold value;

FIG. 3 is a diagram to show an example of TCI control in a case where scheduling offset is equal to or greater than a threshold value and tci-PresentInDCI is not enabled;

FIG. 4 is a diagram to show a TCI state for a PDSCH in option 1;

FIG. 5 is a diagram to show a TCI state for a PDSCH in option 2;

FIG. 6 is a diagram to show an example of TCI control for a PDSCH with scheduling offset being less than a threshold value or equal to or greater than the threshold value;

FIG. 7 is a diagram to show an example of TCI control in a case where at least one PDSCH is non-overlapping with a time resource for another PDSCH;

FIG. 8 is a diagram to show an example of a schematic structure of a radio communication system according to one embodiment;

FIG. 9 is a diagram to show an example of a structure of a base station according to one embodiment;

FIG. 10 is a diagram to show an example of a structure of a user terminal according to one embodiment; and

FIG. 11 is a diagram to show an example of a hardware structure of the base station and the user terminal according to one embodiment.

### DESCRIPTION OF EMBODIMENTS

### (TCI, Spatial Relation, QCL)

For NR, control of reception processing (for example, at least one of reception, demapping, demodulation, and decoding) and transmission processing (for example, at least one of transmission, mapping, precoding, modulation, and coding) of at least one of a signal and a channel (expressed hereinafter as a signal/channel) in a UE based on a transmission configuration indication state (TCI state) is under study.

The TCI state may be a state applied to a downlink signal/channel. A state that corresponds to the TCI state applied to an uplink signal/channel may be expressed as spatial relation.

The TCI state is information related to quasi-co-location (QCL) of the signal/channel, and may be referred to as a spatial reception parameter, spatial relation information, and so on. The TCI state may be configured for the UE for each channel or for each signal. The TCI state, QCL, and QCL assumption may be interchangeably interpreted.

Note that in the present disclosure, a DL TCI state, a UL spatial relation, a UL TCI state, and the like may be interchangeably interpreted.

QCL is an indicator indicating statistical properties of the signal/channel. For example, when a certain signal/channel and another signal/channel are in a relationship of QCL, it may be indicated that it is assumable that at least one of Doppler shift, a Doppler spread, an average delay, a delay spread, and a spatial parameter (for example, a spatial reception parameter (spatial Rx parameter)) is the same (the relationship of QCL is satisfied in at least one of these) between such a plurality of different signals/channels.

Note that the spatial reception parameter may correspond to a receive beam of the UE (for example, a receive analog beam), and the beam may be identified based on spatial QCL. The QCL (or at least one element in the relationship of QCL) in the present disclosure may be interpreted as sQCL (spatial QCL).

For the QCL, a plurality of types (QCL types) may be defined. For example, four QCL types A to D may be provided, which have different parameter(s) (or parameter set(s)) that can be assumed to be the same, and such parameter(s) (which may be referred to as QCL parameter(s)) are described below:
QCL type A (QCL-A): Doppler shift, Doppler spread, average delay, and delay spread,
QCL type B (QCL-B): Doppler shift and Doppler spread,
QCL type C (QCL-C): Doppler shift and Average delay, and
QCL type D (QCL-D): Spatial reception parameter.

A case that the UE assumes that a certain control resource set (CORESET), channel, or reference signal is in a relationship of specific QCL (for example, QCL type D) with another CORESET, channel, or reference signal may be referred to as QCL assumption.

The UE may determine at least one of a transmit beam (Tx beam) and a receive beam (Rx beam) of the signal/channel, based on the TCI state or the QCL assumption of the signal/channel.

The TCI state may be, for example, information related to QCL between a channel as a target (in other words, a reference signal (RS) for the channel) and another signal (for example, another RS). The TCI state may be configured (indicated) by higher layer signaling or physical layer signaling, or a combination of these.

In the present disclosure, the higher layer signaling may be, for example, any one or combinations of Radio Resource Control (RRC) signaling, Medium Access Control (MAC) signaling, broadcast information, and the like.

The MAC signaling may use, for example, a MAC control element (MAC CE), a MAC Protocol Data Unit (PDU), or the like. The broadcast information may be, for example, a master information block (MIB), a system information block (SIB), minimum system information (Remaining Minimum System Information (RMSI)), other system information (OSI), or the like.

The physical layer signaling may be, for example, downlink control information (DCI).

A channel for which the TCI state or spatial relation is configured (specified) may be, for example, at least one of a downlink shared channel (Physical Downlink Shared Channel (PDSCH)), a downlink control channel (Physical Downlink Control Channel (PDCCH)), an uplink shared channel (Physical Uplink Shared Channel (PUSCH)), and an uplink control channel (Physical Uplink Control Channel (PUCCH)).

The RS to have a QCL relationship with the channel may be, for example, at least one of a synchronization signal block (SSB), a channel state information reference signal (CSI-RS), a reference signal for measurement (Sounding Reference Signal (SRS)), a CSI-RS for tracking (also referred to as a Tracking Reference Signal (TRS)), and a reference signal for QCL detection (also referred to as a QRS).

The SSB is a signal block including at least one of a primary synchronization signal (PSS), a secondary synchronization signal (SSS), and a broadcast channel (Physical Broadcast Channel (PBCH)). The SSB may be referred to as an SS/PBCH block.

An information element of the TCI state (“TCI-state IE” of RRC) configured using higher layer signaling may include one or a plurality of pieces of QCL information (one or a plurality of QCL information, “QCL-Info”). The QCL information may include at least one of information related to the RS to have a QCL relationship (RS relation information) and information indicating a QCL type (QCL type information). The RS relation information may include information such as an index of the RS (for example, an SSB index, or a non-zero power CSI-RS (NZP CSI-RS) resource ID (Identifier)), an index of a cell in which the RS is located, and an index of a Bandwidth Part (BWP) in which the RS is located.

In Rel-15 NR, as the TCI state for at least one of the PDCCH and PDSCH, both an RS of QCL type A and an RS of QCL type D or only the RS of QCL type A can be configured for the UE.

When the TRS is configured as the RS of QCL type A, it is assumed that the TRS is different from a demodulation reference signal (DMRS) for the PDCCH or PDSCH and the same TRS is periodically transmitted for a long time. The UE can calculate an average delay, a delay spread, and the like by measuring the TRS.

The UE for which the TRS is configured as the RS of QCL type A with respect to a TCI state for the DMRS for the PDCCH or PDSCH can assume that parameters of QCL type A (average delays, delay spreads, and the like) of the DMRS for the PDCCH or PDSCH and the TRS are the same, and thus can obtain parameters of type A (average delay, delay spread, and the like) for the DMRS for the PDCCH or PDSCH on the basis of a measurement result of the TRS. When performing a channel estimation of at least one of the PDCCH and PDSCH, the UE can perform the channel estimation with higher accuracy by using the measurement result of the TRS.

The UE for which the RS of QCL type D is configured can determine a UE receive beam (spatial domain reception filter or UE spatial domain reception filter) by using the RS of QCL type D.

An RS of QCL type X in a TCI state may mean an RS being in a QCL type X relationship with (a DMRS for) a certain channel/signal, and this RS may be referred to as a QCL source of QCL type X in the TCI state.

### (TCI State for PDSCH)

A TCI state list (size: 1 to 128 bits) indicating TCI states for the PDSCH may be configured for the UE, and up to 8 active TCI states may be activated by a MAC CE. For application of the TCI state for the PDSCH, a plurality of cases are conceivable as follows.

### <Case 0>

When tci-PresentInDCI that is a parameter indicating whether a field (for example, a TCI field) for specifying the TCI state is present in DCI is enabled by RRC, a 3-bit DCI field (TCI field) may be present in a certain DCI format (DL assignment), and the DCI field may indicate any (one) of TCI states out of up to 8 active TCI states for the PDSCH. The certain DCI format may be, for example, DCI format 1_1.

### <Case 1>

When tci-PresentInDCI is not enabled by the RRC, the 3-bit DCI field (TCI field) is absent in DCI format 1_1 (DL assignment), and thus the DCI field is not capable of indicating any (one) of TCI states out of up to 8 active TCI states for the PDSCH. In this case, the UE applies a default TCI state to the PDSCH.

For example, when tci-PresentInDCI is not enabled (the PDSCH is scheduled by a DCI format without presence of TCI fields) and scheduling offset is equal to or greater than a threshold value (timeDurationForQCL), the UE may assume that the default TCI state is a TCI state for a scheduling CORESET (used CORESET) (identical to the TCI state), and may apply the TCI state to the PDSCH.

In the present disclosure, the scheduling offset is duration (time offset) between reception of DL DCI (PDCCH) and reception of a corresponding PDSCH. The threshold value (timeDurationForQCL) compared with the scheduling offset may be based on UE capability reported for determination of PDSCH antenna port QCL.

### <Case 2>

When the scheduling offset is less than the threshold value regardless of whether tci-PresentInDCI is enabled, the UE does not apply (fails to apply) a TCI state specified by the DCI to reception of a corresponding PDSCH. In other words, the UE does not perform switching of (fails to switch) the TCI state for the PDSCH based on the DCI. In this case, the UE applies a default TCI state. The default TCI state may be a TCI state corresponding to the lowest CORESET ID in the latest monitored slot.

For example, when all TCI code points are mapped to a single TCI state without dependence on configurations of tci-PresentInDCI and tci-PresentInDCI-ForFormat1_2 in an RRC connected mode and the scheduling offset is less than the threshold value, the UE assumes that a DM-RS port for the PDSCH in a serving cell is QCL with an RS related to a QCL parameter used for QCL indication of a PDCCH of a specific CORESET. The specific CORESET is, in one or more CORESETs monitored by the UE in an active BWP of the serving cell, related to a monitored search space with the lowest controlResourceSetId in the latest slot. Note that in the present disclosure, a condition “in the latest slot (in the latest monitored slot)” may be omitted.

### <Case 3>

When using cross-carrier scheduling, the UE applies a default TCI state different from a default TCI state in a case where non-cross-carrier scheduling is used (for example, case 1 and case 2). When a PDCCH and a PDSCH are present in the same CC, the UE does not predict that the scheduling offset is less than the threshold value. When the PDCCH and the PDSCH are present in different CCs, the UE applies a TCI state with the lowest TCI state ID in an active BWP of a scheduled CC.

For example, when a CORESET associated with a search space set for cross-carrier scheduling is configured for the UE and a PDCCH to transmit DCI and a PDSCH scheduled by the DCI are transmitted on the same carrier, the UE assumes that tci-PresentInDCI is enabled or tci-PresentInDCI-ForFormat1_2 is configured for the CORESET. When “QCL-Type D” is included in one or more TCI states configured for a serving cell scheduled by the search space set, the UE predicts that time offset (scheduling offset) between reception of a PDCCH detected by the search space set and reception of a corresponding PDSCH is equal to or greater than the threshold value (timeDurationForQCL).

When a PDCCH to transmit scheduling DCI is received on one component carrier and a PDSCH scheduled by the DCI is received on another component carrier, the following (1) and (2) may be employed.

(1) The threshold value is determined on the basis of subcarrier spacing (μPDSCH) of the scheduled PDSCH. When μPDCCH (subcarrier spacing of the PDCCH)<μPDSCH, additional timing delay d is added to the threshold value.

(2) In both a case where tci-PresentInDCI is set to “enabled” and offset between reception of DL DCI and a corresponding PDSCH is less than the threshold value and a case where tci-PresentInDCI is not configured, the UE obtains QCL assumption (TCI state) for the scheduled PDSCH from an active TCI state having the lowest ID applicable to a PDSCH in an active BWP of a scheduled cell.

### <Example of Application of TCI State>

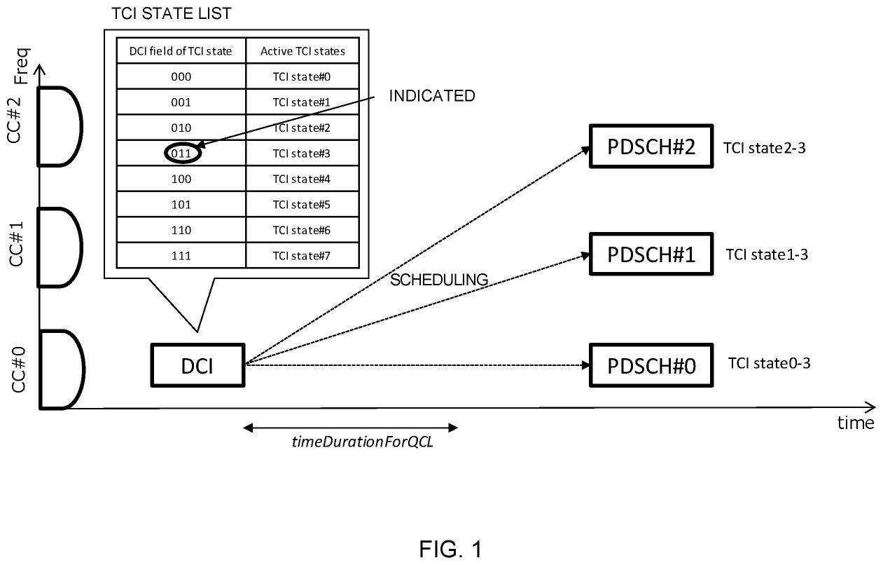

FIG. 1 is a diagram to show an example of TCI control by the DCI. In the example of FIG. 1, it is assumed that tci-PresentInDCI is enabled and the scheduling offset is equal to or greater than the threshold value. In this case, control of the TCI state by the DCI (at a DCI level) is possible.

In FIG. 1, tci-PresentInDCI is enabled, and thus active TCI states are configured in the DCI field. As shown in a TCI state list, it is assumed that “011” corresponding to “TCI state #3” is configured/indicated in the DCI field indicating the TCI state. In this case, the UE applies, to PDSCH #0, PDSCH #1, and PDSCH #2 scheduled by the DCI, “TCI state 0-3,” “TCI state 1-3,” and “TCI state 2-3” corresponding to “TCI state #3.” The UE may apply the same TCI state “TCI state #3” or the like to PDSCH #0, PDSCH #1, and PDSCH #2 scheduled by the DCI. In other words, the above-described case 0 is employed. Note that the TCI state list may be configured by higher layer signaling, and may be configured for each CC and selected by a common DCI field.

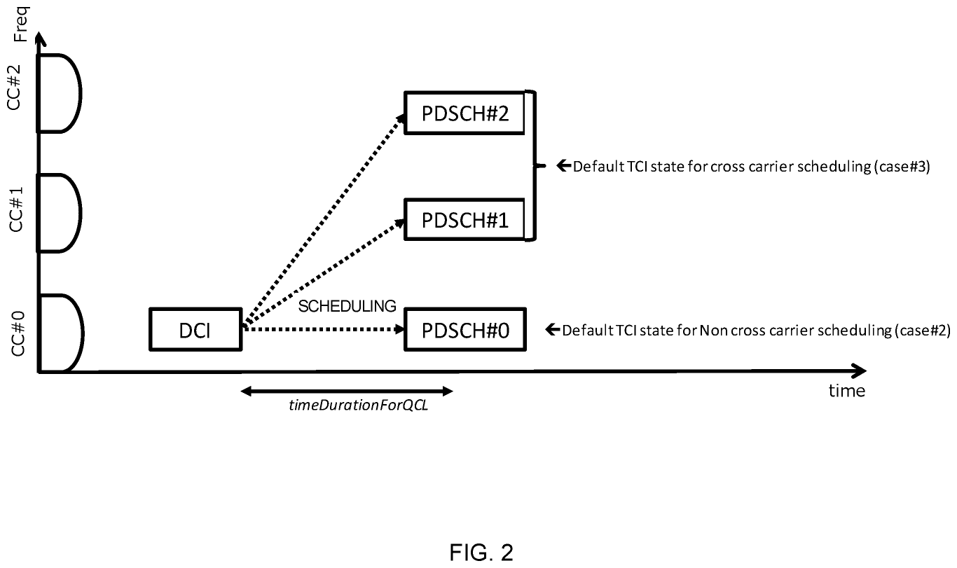

FIG. 2 is a diagram to show an example of TCI control in a case where the scheduling offset is less than the threshold value. As shown in FIG. 2, when the scheduling offset is less than the threshold value, the DCI fails to switch the TCI state for the PDSCH.

In the example of FIG. 2, the UE applies the default TCI state described in the above-described case 2 to PDSCH #0 transmitted on the same CC (CC #0) as that for the DCI (PDCCH). On the other hand, the UE applies, to PDSCH #1 and PDSCH #2 transmitted on CCs (CC #1 and CC #2) different from that for the DCI (PDCCH), a default TCI state different from the default TCI state of case 1 and case 2, as described in the above-described case 3. In this case, different TCI states are assumed in respective CCs, and thus it is difficult to receive the PDSCHs with one beam.

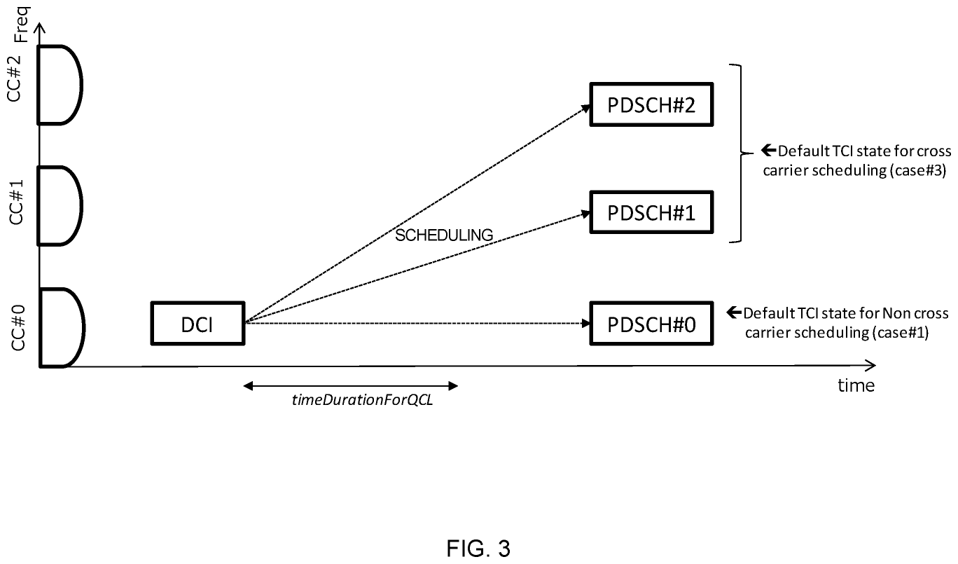

FIG. 3 is a diagram to show an example of TCI control in a case where the scheduling offset is equal to or greater than the threshold value and tci-PresentInDCI is not enabled. tci-PresentInDCI is not enabled, and thus it is assumed that the DCI field indicating the TCI state is 0 bit. In FIG. 3, the scheduling offset is equal to or greater than the threshold value. Note, however, that since tci-PresentInDCI is not enabled, the DCI fails to switch the TCI state for the PDSCH.

In the example of FIG. 3, the UE applies the default TCI state described in the above-described case 1 to PDSCH #0 transmitted on the same CC (CC #0) as that for the DCI (PDCCH). On the other hand, the UE applies, to PDSCH #1 and PDSCH #2 transmitted on CCs (CC #1 and CC #2) different from that for the DCI (PDCCH), a default TCI state different from the default TCI state of case 1 and case 2, as described in the above-described case 3. In this case, different TCI states are assumed in respective CCs, and thus it is difficult to receive the PDSCHs with one beam.

As mentioned above, when one piece of DCI (PDCCH) simultaneously schedules PDSCHs respectively transmitted on a plurality of CCs, how to configure a TCI state applied on each CC is an issue. Unless the TCI state applied on each CC is configured appropriately, communication quality may deteriorate. For example, in cases as illustrated in FIG. 2 and FIG. 3, a different TCI state is assumed in each CC, and thus it is difficult to receive the PDSCH with one beam. When multiple beams are used simultaneously, processing by the UE and the like is complicated.

Thus, the inventors of the present invention came up with the idea of a terminal that, when one piece of the DCI simultaneously schedules PDSCHs respectively transmitted on a plurality of component carriers (CCs), applies a TCI state to the PDSCHs by using a common rule. According to one aspect of the present disclosure, when one piece of DCI (PDCCH) simultaneously schedules PDSCHs transmitted on a plurality of CCs, it is possible to apply an appropriate TCI state to the PDSCHs.

Embodiments according to the present disclosure will be described in detail with reference to the drawings as follows. The radio communication methods according to respective embodiments may each be employed individually, or may be employed in combination. Note that in the present disclosure, “A/B” may be interpreted as “at least one of A and B.” The PDSCH in the present disclosure may be interpreted as a PUSCH.

### (Radio Communication Method)

### First Embodiment

When DCI is received and one piece of the DCI (PDCCH) simultaneously schedules PDSCHs respectively transmitted on a plurality of CCs, a UE applies a TCI state (default TCI state) based on a common rule to the PDSCHs. The TCI state applied to the PDSCHs is determined by methods described in option 1 to option 4 below. The TCI state based on the common rule may be interpreted as a common TCI state, the same TCI state, a specific TCI state, or a pre-configured/indicated TCI state.

### [Option 1]

The UE may apply a rule (for example, a rule described in the above-described case 3) applied in cross-carrier scheduling to a TCI state for a PDSCH transmitted with non-cross-carrier scheduling. In other words, the UE may apply, to a TCI state (default TCI state) for a PDSCH transmitted on the same CC as that for the DCI, a TCI state (default TCI state) for a PDSCH transmitted on a CC (a second CC) different from a CC (a first CC) on which the DCI is transmitted. For example, the UE may apply, as a default TCI state for a PDSCH received on each CC/BWP, a TCI state (TCI state for the PDSCH) corresponding to the lowest (or the highest) TCI state ID in an active DL BWP of a scheduled CC.

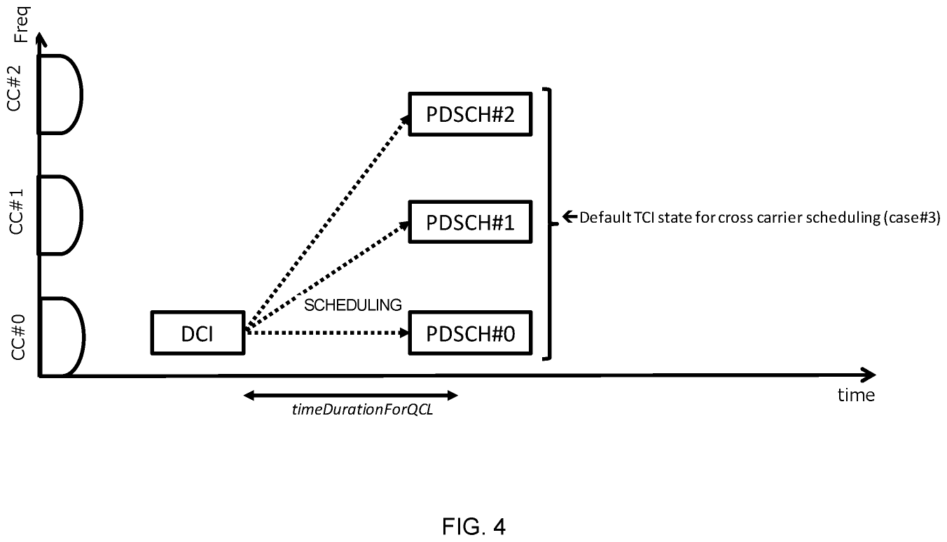

FIG. 4 is a diagram to show the TCI state for the PDSCH in option 1. In an example shown in FIG. 4, a TCI state based on a rule (case 3) applied in cross-carrier scheduling is applied to each of PDSCH #0, PDSCH #1, and PDSCH #2.

In option 1, a TCI state list for the PDSCH may always be configured on each BWP/CC on which the PDSCH is scheduled (constraint 1-1). At least one TCI state may be activated on each BWP/CC on which the PDSCH is scheduled (constraint 1-2). Note that either or both of constraint 1-1 and constraint 1-2 may be employed.

### [Option 2]

A rule/TCI state applied in non-cross-carrier scheduling (for example, a rule/default TCI state described in the above-described case 1 or case 2) may be applied to a TCI state for a PDSCH transmitted with cross-carrier scheduling. In other words, the UE may apply, to a TCI state (default TCI state) for a PDSCH transmitted on a CC (a second CC) different from that for the DCI (a first CC for the DCI), a TCI state (default TCI state) for a PDSCH transmitted on the same CC as that for the DCI. For example, the UE may apply, as a default TCI state for a PDSCH received on each CC/BWP, a TCI state with the lowest (or the highest) CORESET ID (controlResourceSetId) in the latest slot in an active DL BWP of the CC.

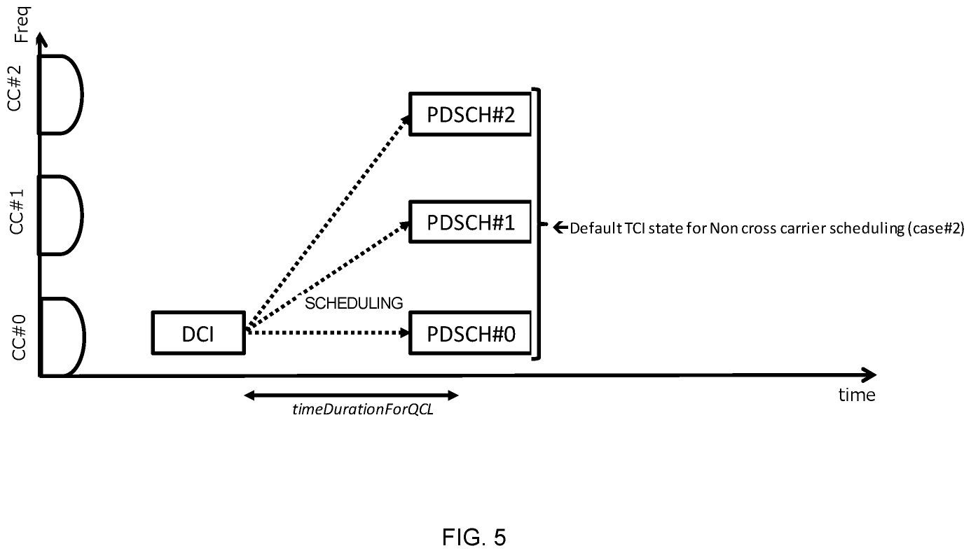

FIG. 5 is a diagram to show the TCI state for the PDSCH in option 2. In an example shown in FIG. 5, a TCI state based on a rule (case 2) applied in non-cross-carrier scheduling is applied to each of PDSCH #0, PDSCH #1, and PDSCH #2.

In option 2, at least one CORESET may always be configured on each BWP/CC on which the PDSCH is scheduled (constraint 2-1). A CORESET with at least one active TCI state may be present on each BWP/CC on which the PDSCH is scheduled (constraint 2-2). Note that either or both of constraint 2-1 and constraint 2-2 may be employed.

### [Option 3]

The default TCI state applied to the PDSCH may be configured/indicated by higher layer signaling. The UE may apply the TCI state configured/indicated by the higher layer signaling to the PDSCH. For example, the UE may apply, as a default TCI state for a PDSCH received on each CC/BWP, a default TCI state configured/indicated by RRC/MAC CE. In this case, the default TCI state may always be configured/indicated by the higher layer signaling on each BWP/CC on which the PDSCH is scheduled. Note that the UE may apply a default TCI state configured/indicated by the DCI.

### [Option 4]

When the default TCI state is configured/indicated by the higher layer signaling, the UE may apply the TCI state to the PDSCH (employ option 3), and the TCI state is not configured/indicated by the higher layer signaling, the UE may employ a method according to option 1 or option 2.

### [Option 5]

The UE may assume (apply), as the default TCI state for the PDSCH, a TCI state for a PDSCH received in the past. For example, the UE may assume (apply), in a scheduling CC (a CC on which the DCI is transmitted or a CC to schedule another CC), the TCI state for the PDSCH received in the past. For example, the UE may assume (apply), in a scheduled CC (a CC on which the PDSCH is transmitted or a CC scheduled from another CC), the TCI state for the PDSCH received in the past.

The above-described “PDSCH received in the past” may be limited to a PDSCH scheduled by DCI for which simultaneous scheduling of a plurality of CCs is configured. The above-described “PDSCH received in the past” may include a (normal) PDSCH in a case where one piece of DCI has scheduled the PDSCH of one CC.

Any one of option 1 to option 5 may be defined, or a plurality of options out of option 1 to option 5 may be defined. An employed option may be configured/indicated for the UE by higher layer signaling, or an option determined by a network according to UE capability report may be configured/indicated for the UE.

As described above, according to one aspect of the present disclosure, when one piece of DCI (PDCCH) simultaneously schedules PDSCHs transmitted on a plurality of CCs, it is possible to apply an appropriate TCI state to the PDSCHs.

### [Others 1]

SCS of the scheduling CC and SCS of the scheduled CC are possibility different from each other. In that case, any one of the following (1) to (3) may be employed.

(1) The UE compares the scheduling offset with a threshold value by using subcarrier spacing (SCS) of the scheduling CC as a reference.
(2) The UE compares the scheduling offset with the threshold value by using the SCS of the scheduled CC as a reference.
(3) Considering both the SCS of the scheduling CC and the SCS of the scheduled CC, the UE compares the scheduling offset with the threshold value by calculating, with a conversion formula with consideration of an SCS difference, absolute time of the scheduling offset.

Note that in the present disclosure, the threshold value and timeDurationForQCL may be interchangeably interpreted. The threshold value in a case where one-time (simultaneous) scheduling of a plurality of CCs is performed may be different from timeDurationForQCL. In that case, the threshold value may be configured/indicated for the UE by higher layer signaling, or a threshold value determined by the network in response to UE capability report may be configured/indicated for the UE.

### [Others 2]

As a method of configuration of a higher layer parameter and a DCI field in a case where one-time (simultaneous) scheduling of a plurality of CCs is performed, a method according to the following (1) to (3) is conceivable. Note that it is assumed that the DCI field is a field for at least one of a TCI state, time domain resource assignment (Time Domain Resource Assignment or allocation (TDRA)), and frequency domain resource assignment (Frequency Domain Resource Assignment or allocation (FDRA)).

(1) The higher layer parameter, the number of which corresponds to one CC, is configured, and the UE applies, to all scheduled CCs, a common value indicated by the DCI field the length of which corresponds to one CC.
(2) The higher layer parameter, the number of which corresponds to a plurality of CCs, is configured, and the UE applies, to each scheduled CC, a value indicated by a common DCI field the length of which corresponds to one CC.
(3) The higher layer parameter, the number of which corresponds to a plurality of CCs, is configured, and the UE may apply, to each of the scheduled CCs, a value indicated by each DCI field enhanced depending on the number of CCs. In this case, for example, the DCI field, the length of which corresponds to one CC, is 3 bits, and the DCI field is enhanced to 6 bits when the DCI field, the length of which corresponds to two CCs, is configured. Therefore, it is possible to perform scheduling of each CC with more flexibility. In this case, the number of bits is determined before blind detection of the DCI, and thus it is necessary that the number of scheduled CCs is configured by a higher layer beforehand.

When the DCI field is enhanced, for example, the number of bits obtained by simply multiplying the current number of bits of the DCI field by the number of CCs may be applied to a new DCI field. For example, when the current number of bits is 3 bits, it is only necessary that 3 bits are multiplied by the number of scheduled CCs.

Alternatively, a value (the number of bits) obtained by multiplying a reduced value of the current number of bits of the DCI field by the number of CCs may be applied to the new DCI field. When the current number of bits is 3 bits, for example, 2 bits×the number of scheduled CCs may be the number of bits of the DCI field.

Alternatively, the number of bits of the DCI field of a specific CC may be unchanged, and the DCI field of another CC may be reduced. For example, when the current number of DCI fields is 3 bits, the DCI field of a scheduling CC may remain 3 bits, and 2 bits×the number of scheduled CCs may be applied to the DCI field of another CC.

### <Regarding Application Condition>

A condition (referred to as an application condition) “a case where one piece of DCI (PDCCH) simultaneously schedules PDSCHs respectively transmitted on a plurality of CCs” in the first embodiment may be interpreted as “a case where a DSS is configured,” “a case where simultaneous scheduling of a plurality of CCs is configured,” “a case where DCI of one CC to schedule PDSCHs of a plurality of CCs is configured,” “a case where DCI of M CCs to schedule PDSCHs of N CCs is configured (M≤N),” or “a case where a DSS-related parameter is configured (for example, a case where a parameter “LTE-CRS-ToMatchAround” in servingCellConfig is configured).”

The application condition may be interpreted as “a case where DCI for simultaneous scheduling of a plurality of CCs is received/detected,” “a case where DCI with a dedicated DCI format for simultaneous scheduling of a plurality of CCs is detected,” or “a case where DCI scrambled by a dedicated Radio Network Temporary Identifier (RNTI) for simultaneous scheduling of a plurality of CCs is detected.”

The application condition may be interpreted as “a case where one PDCCH schedules a plurality of PDSCHs on a plurality of BWPs/CCs,” “a case where one PDCCH schedules a plurality of PDSCHs on a plurality of BWPs/CCs and at least one PDSCH is present in the same BWP/CC as a BWP/CC for a scheduling PDSCH,” or “if a plurality of cells with cif-InSchedulingCell the same as the schedulingCellId of CrossCarrierSchedulingConfig are configured.”

The application condition may be interpreted as “a case where tci-PresentInDCI is not enabled or scheduling offset is less than a threshold value reported from the UE.” Note that when TDRA can be independently configured for each CC, there is a possibility that scheduling offset of some CCs is less than a threshold value and scheduling offset of another CC is equal to or greater than the threshold value. In this case, the application condition may be interpreted as “a case where, in all CCs, scheduling offset is less than a threshold value reported by the UE,” “a case where, in at least one CC, scheduling offset is less than a threshold value reported by the UE,” or “a case where, in a CC to schedule at least a PDSCH, scheduling offset is less than a threshold value reported by the UE.”

### Second Embodiment

For example, in a case where time domain allocation (for example, TDRA) can be flexibly configured for each CC, there is a possibility that both a PDSCH with scheduling offset being less than a threshold value (timeDurationForQCL) and a PDSCH with scheduling offset being equal to or greater than the threshold value are present in a plurality of PDSCHs scheduled by one piece of DCI. In this case, a UE may apply a default TCI state to the PDSCH with scheduling offset being less than the threshold value, and may apply a TCI state indicated by the DCI to the PDSCH with scheduling offset being equal to or greater than the threshold value.

“The case where time domain allocation (for example, TDRA) can be flexibly configured for each CC” may mean a case where a method according to (2) and (3) in the above-described “others 2” can be applied to TDRA (a case where the DCI field of (2) and (3) is a DCI field for TDRA). In this case, the DCI field for TDRA may not be 3 bits. When the number of bits of the DCI field for TDRA is X, X may be configured by higher layer signaling, or may be defined by specifications.

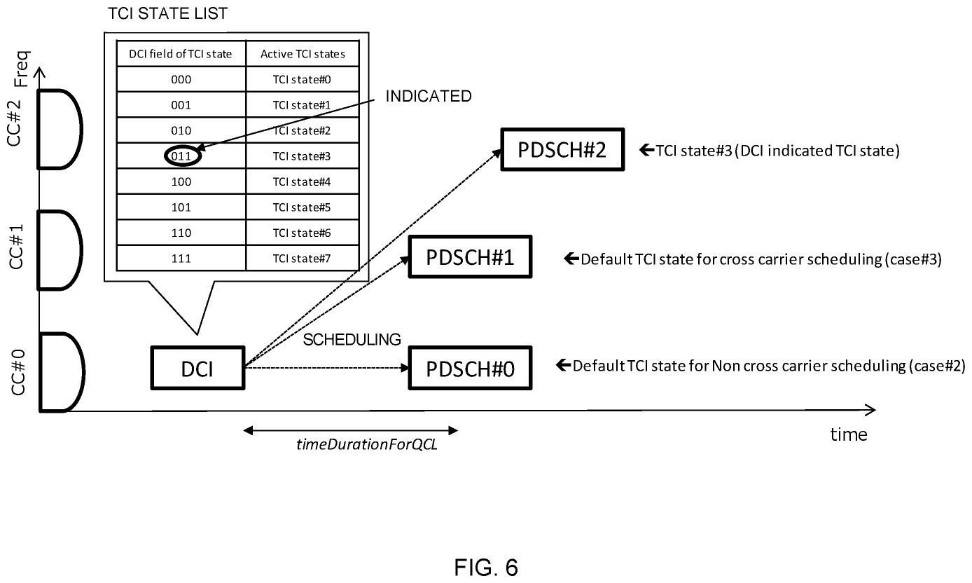

FIG. 6 is a diagram to show an example of TCI control for the PDSCH with scheduling offset being less than the threshold value or equal to or greater than the threshold value. In the example of FIG. 6, scheduling offset of PDSCH #0 and scheduling offset of PDSCH #1 are less than the threshold value. Thus, for example, the UE applies a default TCI state to PDSCH #0 (employs the above-described case 2), and applies another default TCI state to PDSCH #1 (employs the above-described case 3). Moreover, scheduling offset of PDSCH #2 is equal to or greater than the threshold value. Thus, the UE applies a TCI state indicated by the DCI to PDSCH #2.

The UE simultaneously receives the PDSCHs by using different receive beams, and thus control is more complicated. Thus, whether the control of the present embodiment is applicable may be reported by UE capability, and the control of the present embodiment may, only when applicable, be applied. Furthermore, the control of the present embodiment may be applied only when being configured from a network. When the control of the present embodiment is not configured from the network, variation 1 or variation 2 below may be employed.

### [Variation 1]

When scheduling offset of a PDSCH received on at least one CC is less than a threshold value, the UE applies a default TCI state to TCI states (for PDSCHs) on all scheduled CCs.

### [Variation 2]

When scheduling offset of a PDSCH of a scheduling CC is less than a threshold value, the UE applies a default TCI state to TCI states (for PDSCHs) on all scheduled CCs.

### [Variation 3]

When the scheduling offset of the PDSCH of the scheduling CC is equal to or greater than a threshold value, the UE may apply a TCI state indicated by the DCI to TCI states (for PDSCHs) on all scheduled CCs.

### [Variation 4]

The UE may control a TCI state for each PDSCH depending on whether time resources for a plurality of PDSCHs are overlapping with each other.

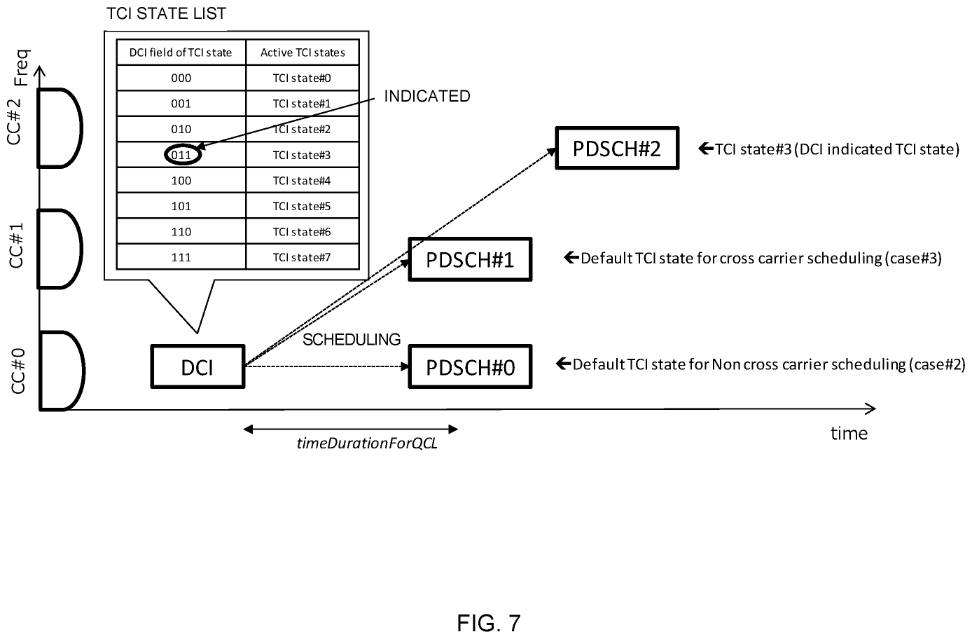

FIG. 7 is a diagram to show an example of the TCI control in a case where at least one PDSCH is non-overlapping with a time resource for another PDSCH. In the example of FIG. 7, time resources for PDSCH #0 and PDSCH #1 and a time resource for PDSCH #2 are non-overlapping with each other. In this case, a default TCI may be applied to PDSCH #0 and PDSCH #1, and a TCI state indicated by the DCI may be applied to PDSCH #2.

In other words, the UE may apply the TCI state indicated by the DCI to a subsequent PDSCH out of non-overlapping PDSCHs. Alternatively, the UE may apply the TCI state indicated by the DCI to all PDSCHs.

As described above, according to one aspect of the present disclosure, even when both a PDSCH with scheduling offset being less than a threshold value and a PDSCH with scheduling offset being equal to or greater than the threshold value are present in a plurality of PDSCHs scheduled by one piece of DCI, it is only necessary that the PDSCHs are received under assumption of one QCL/TCI state in a certain OFDM symbol, and thus a terminal can receive the PDSCHs appropriately.

### (Radio Communication System)

Hereinafter, a structure of a radio communication system according to one embodiment of the present disclosure will be described. In this radio communication system, the radio communication method according to each embodiment of the present disclosure described above may be used alone or may be used in combination for communication.

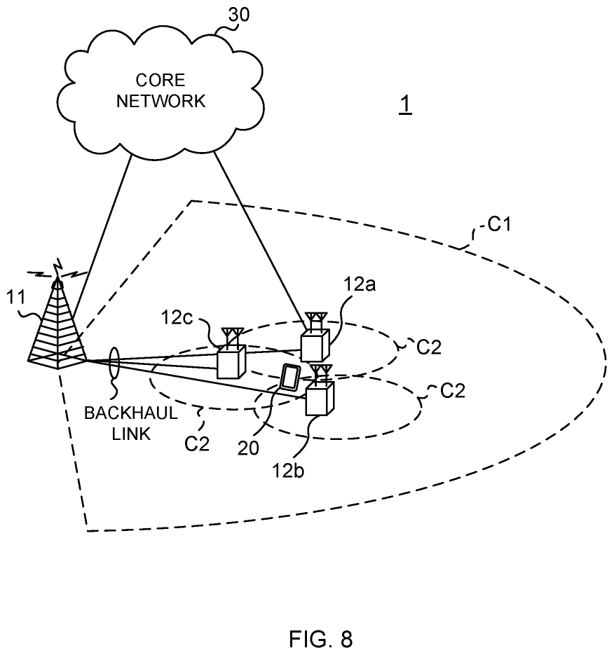

FIG. 8 is a diagram to show an example of a schematic structure of the radio communication system according to one embodiment. The radio communication system 1 may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHz or less (sub-6 GHz), and FR2 may be a frequency band which is higher than 24 GHz (above-24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-s-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data”, and the PUSCH may be interpreted as “UL data”.

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a certain search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be also referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be also referred to as a “reference signal.”

In the radio communication system 1, a sounding reference signal (SRS), a demodulation reference signal (DMRS), and so on may be communicated as an uplink reference signal (UL-RS). Note that DMRS may be referred to as a “user terminal specific reference signal (UE-specific Reference Signal).”

### (Base Station)

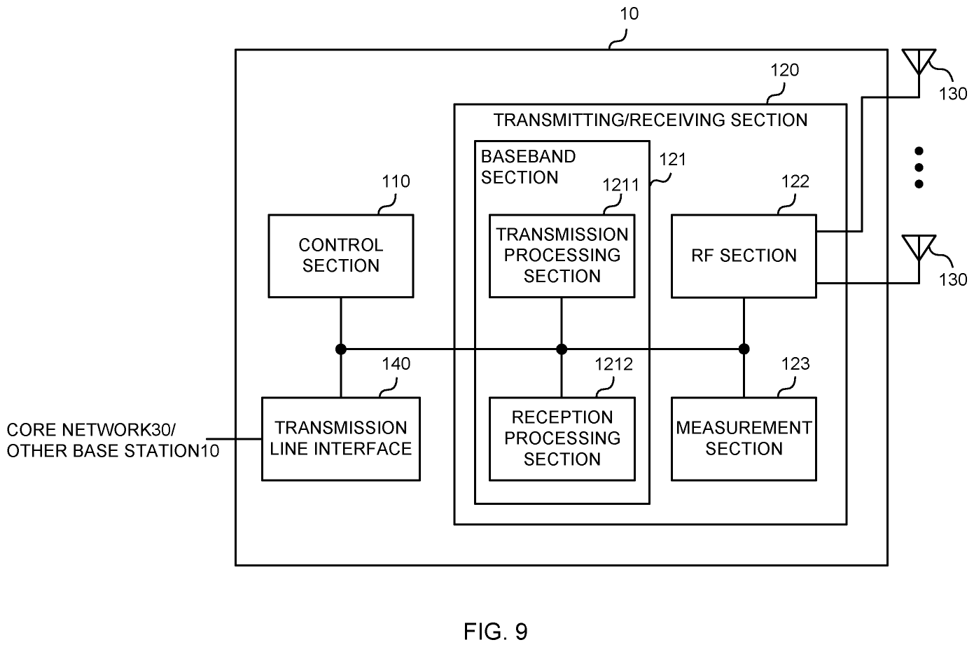

FIG. 9 is a diagram to show an example of a structure of the base station according to one embodiment. The base station 10 includes a control section 110, a transmitting/receiving section 120, transmitting/receiving antennas 130 and a communication path interface (transmission line interface) 140. Note that the base station 10 may include one or more control sections 110, one or more transmitting/receiving sections 120, one or more transmitting/receiving antennas 130, and one or more communication path interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the communication path interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The communication path interface 140 may perform transmission/reception (backhaul signaling) of a signal with an apparatus included in the core network 30 or other base stations 10, and so on, and acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the communication path interface 140.

Note that the transmitting/receiving section 120 may transmit downlink control information (DCI). When one piece of the DCI simultaneously schedules PDSCHs respectively transmitted on a plurality of component carriers (CCs), a TCI state based on a common rule may be applied to the PDSCHs.

### (User Terminal)

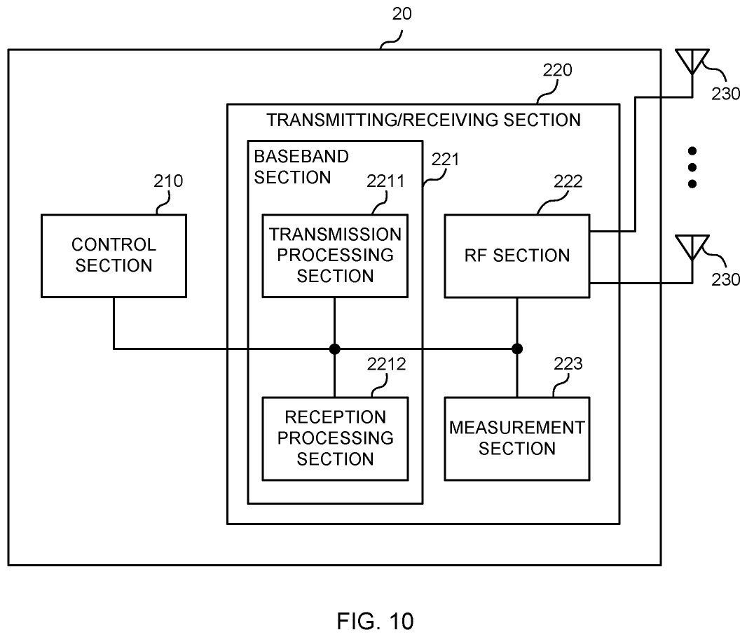

FIG. 10 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a certain channel (for example, PUSCH), the DFT processing as the above-described transmission processing to transmit the channel by using a DFT-s-OFDM waveform if transform precoding is enabled, and otherwise, does not need to perform the DFT processing as the above-described transmission process.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply a receiving process such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220 and the transmitting/receiving antennas 230.

Note that the transmitting/receiving section 220 may receive downlink control information (DCI).

The control section 210 may, when one piece of the DCI simultaneously schedules PDSCHs respectively transmitted on a plurality of component carriers (CCs), apply a TCI state based on a common rule to the PDSCHs. For example, the control section 210 may apply, to a TCI state for a PDSCH transmitted on a same CC as a CC for the DCI, a TCI state for a PDSCH transmitted on a CC (a second CC) different from the CC (a first CC) for the DCI. For example, the control section 210 may apply, to a TCI state for a PDSCH transmitted on a CC (a second CC) different from a CC (a first CC) for the DCI, a TCI state for a PDSCH transmitted on a same CC as the CC for the DCI. For example, the control section 210 may, when a TCI state applied to the PDSCHs is indicated by higher layer signaling, apply the indicated TCI state to the PDSCHs.

### (Hardware Structure)

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (two or more physically or logically separate apparatus), for example, via wire, wireless, or the like, and using these plurality of pieces of apparatus (these plurality of apparatus). The functional blocks may be implemented by combining softwares into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

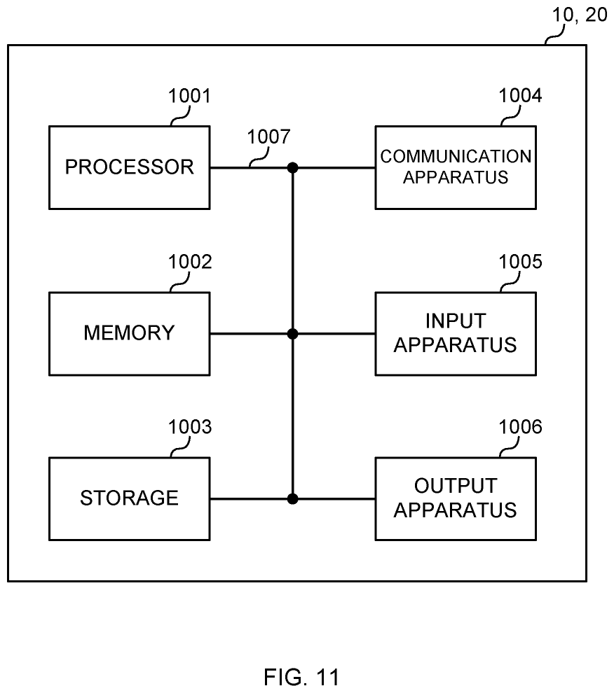

For example, a base station, a user terminal, and so on according to one embodiment of the present disclosure may function as a computer that executes the processes of the radio communication method of the present disclosure. FIG. 11 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably interpreted. The hardware structure of the base station 10 and the user terminal 20 may be configured to include one or more of apparatuses shown in the drawings, or may be configured not to include part of apparatuses.

For example, although only one processor 1001 is shown, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminals 20 is implemented, for example, by allowing certain software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least part of the above-described control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus.”

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the above-described transmitting/receiving section 120 (220), the transmitting/receiving antennas 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus (between apparatus).

Also, the base station 10 and the user terminals 20 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware (at least one of these hardware).

### (Variations)

Note that the terminology described in the present disclosure and the terminology that is needed to understand the present disclosure may be replaced by other terms that convey the same or similar meanings. For example, a “channel,” a “symbol,” and a “signal” (or signaling) may be interchangeably interpreted. Also, “signals” may be “messages.” A reference signal may be abbreviated as an “RS,” and may be referred to as a “pilot,” a “pilot signal,” and so on, depending on which standard applies. Furthermore, a “component carrier (CC)” may be referred to as a “cell,” a “frequency carrier,” a “carrier frequency” and so on.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a particular filter processing performed by a transceiver in the frequency domain, a particular windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably interpreted.

For example, one subframe may be referred to as a “TTI,” a plurality of consecutive subframes may be referred to as a “TTI,” or one slot or one mini-slot may be referred to as a “TTI.” That is, at least one of a subframe and a TTI may be a subframe (1 ms) in existing LTE, may be a shorter period than 1 ms (for example, 1 to 13 symbols), or may be a longer period than 1 ms. Note that a unit expressing TTI may be referred to as a “slot,” a “mini-slot,” and so on instead of a “subframe.”

Here, a TTI refers to the minimum time unit of scheduling in radio communication, for example. For example, in LTE systems, a base station schedules the allocation of radio resources (such as a frequency bandwidth and transmit power that are available for each user terminal) for the user terminal in TTI units. Note that the definition of TTIs is not limited to this.

TTIs may be transmission time units for channel-encoded data packets (transport blocks), code blocks, or codewords, or may be the unit of processing in scheduling, link adaptation, and so on. Note that, when TTIs are given, the time interval (for example, the number of symbols) to which transport blocks, code blocks, codewords, or the like are actually mapped may be shorter than the TTIs.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot” and so on. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),” a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for the UL) and a DL BWP (BWP for the DL). One or a plurality of BWPs may be configured in one carrier for a UE.

At least one of configured BWPs may be active, and a UE does not need to assume to transmit/receive a certain signal/channel outside active BWPs. Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the information, parameters, and so on described in the present disclosure may be represented in absolute values or in relative values with respect to certain values, or may be represented in another corresponding information. For example, radio resources may be specified by certain indices.

The names used for parameters and so on in the present disclosure are in no respect limiting. Furthermore, mathematical expressions that use these parameters, and so on may be different from those expressly disclosed in the present disclosure. For example, since various channels (PUCCH, PDCCH, and so on) and information elements can be identified by any suitable names, the various names allocated to these various channels and information elements are in no respect limiting.

The information, signals, and so on described in the present disclosure may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output in at least one of from higher layers to lower layers and from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Reporting of information is by no means limited to the aspects/embodiments described in the present disclosure, and other methods may be used as well. For example, reporting of information in the present disclosure may be implemented by using physical layer signaling (for example, downlink control information (DCI), uplink control information (UCI), higher layer signaling (for example, Radio Resource Control (RRC) signaling, broadcast information (master information block (MIB), system information blocks (SIBs), and so on), Medium Access Control (MAC) signaling and so on), and other signals or combinations of these.

Note that physical layer signaling may be referred to as “Layer 1/Layer 2 (L1/L2) control information (L1/L2 control signals),” “L1 control information (L1 control signal),” and so on. Also, RRC signaling may be referred to as an “RRC message,” and can be, for example, an RRC connection setup message, an RRC connection reconfiguration message, and so on. Also, MAC signaling may be reported using, for example, MAC control elements (MAC CEs).

Also, reporting of certain information (for example, reporting of “X holds”) does not necessarily have to be reported explicitly, and can be reported implicitly (by, for example, not reporting this certain information or reporting another piece of information).

Determinations may be made in values represented by one bit (0 or 1), may be made in Boolean values that represent true or false, or may be made by comparing numerical values (for example, comparison against a certain value).

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using at least one of wired technologies (coaxial cables, optical fiber cables, twisted-pair cables, digital subscriber lines (DSL), and so on) and wireless technologies (infrared radiation, microwaves, and so on), at least one of these wired technologies and wireless technologies are also included in the definition of communication media.

The terms “system” and “network” used in the present disclosure can be used interchangeably. The “network” may mean an apparatus (for example, a base station) included in the network.

In the present disclosure, the terms such as “precoding,” a “precoder,” a “weight (precoding weight),” “quasi-co-location (QCL),” a “Transmission Configuration Indication state (TCI state),” a “spatial relation,” a “spatial domain filter,” a “transmit power,” “phase rotation,” an “antenna port,” an “antenna port group,” a “layer,” “the number of layers,” a “rank,” a “resource,” a “resource set,” a “resource group,” a “beam,” a “beam width,” a “beam angular degree,” an “antenna,” an “antenna element,” a “panel,” and so on can be used interchangeably.

In the present disclosure, the terms such as a “base station (BS),” a “radio base station,” a “fixed station,” a “NodeB,” an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a small cell,” a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be device mounted on a moving object or a moving object itself, and so on. The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor, and the like.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D),” “Vehicle-to-Everything (V2X),” and the like). In this case, user terminals 20 may have the functions of the base stations 10 described above. The words “uplink” and “downlink” may be interpreted as the words corresponding to the terminal-to-terminal communication (for example, “side”). For example, an uplink channel, a downlink channel and so on may be interpreted as a side channel.

Likewise, the user terminal in the present disclosure may be interpreted as base station. In this case, the base station 10 may have the functions of the user terminal 20 described above.

Actions which have been described in the present disclosure to be performed by a base station may, in some cases, be performed by upper nodes. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

The aspects/embodiments illustrated in the present disclosure may be used individually or in combinations, which may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG) (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced based on these. A plurality of systems may be combined (for example, a combination of LTE or LTE-A and 5G, and the like) and applied.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

The term “judging (determining)” as in the present disclosure herein may encompass a wide variety of actions. For example, “judging (determining)” may be interpreted to mean making “judgments (determinations)” about judging, calculating, computing, processing, deriving, investigating, looking up, search and inquiry (for example, searching a table, a database, or some other data structures), ascertaining, and so on.

Furthermore, “judging (determining)” may be interpreted to mean making “judgments (determinations)” about receiving (for example, receiving information), transmitting (for example, transmitting information), input, output, accessing (for example, accessing data in a memory), and so on.

In addition, “judging (determining)” as used herein may be interpreted to mean making “judgments (determinations)” about resolving, selecting, choosing, establishing, comparing, and so on. In other words, “judging (determining)” may be interpreted to mean making “judgments (determinations)” about some action.

In addition, “judging (determining)” may be interpreted as “assuming,” “expecting,” “considering,” and the like.

The terms “connected” and “coupled,” or any variation of these terms as used in the present disclosure mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other.” Note that the phrase may mean that “A and B is each different from C.” The terms “separate,” “be coupled,” and so on may be interpreted similarly to “different.”

When terms such as “include,” “including,” and variations of these are used in the present disclosure, these terms are intended to be inclusive, in a manner similar to the way the term “comprising” is used. Furthermore, the term “or” as used in the present disclosure is intended to be not an exclusive disjunction.

For example, in the present disclosure, when an article such as “a,” “an,” and “the” in the English language is added by translation, the present disclosure may include that a noun after these articles is in a plural form.

Now, although the invention according to the present disclosure has been described in detail above, it should be obvious to a person skilled in the art that the invention according to the present disclosure is by no means limited to the embodiments described in the present disclosure. The invention according to the present disclosure can be implemented with various corrections and in various modifications, without departing from the spirit and scope of the invention defined by the recitations of claims. Consequently, the description of the present disclosure is provided only for the purpose of explaining examples, and should by no means be construed to limit the invention according to the present disclosure in any way.

What is claimed is:

1. A terminal comprising:
a receiving section that receives downlink control information (DCI); and
a control section that, when one piece of the DCI simultaneously schedules PDSCHs respectively transmitted on a plurality of component carriers (CCs), applies a TCI state based on a common rule to the PDSCHs.

2. The terminal according to claim 1, wherein
the control section applies, to a TCI state for a PDSCH transmitted on a same CC as a first CC for the DCI, a TCI state for a PDSCH transmitted on a second CC different from the first CC for the DCI.

3. The terminal according to claim 1, wherein
the control section applies, to a TCI state for a PDSCH transmitted on a second CC different from a first CC for the DCI, a TCI state for a PDSCH transmitted on a same CC as the first CC for the DCI.

4. The terminal according to claim 1, wherein
when a TCI state applied to the PDSCHs is indicated by higher layer signaling, the control section applies the indicated TCI state to the PDSCHs.

5. A radio communication method for a terminal comprising:
receiving downlink control information (DCI); and
applying, when one piece of the DCI simultaneously schedules PDSCHs respectively transmitted on a plurality of component carriers (CCs), a TCI state based on a common rule to the PDSCHs.

6. A base station comprising:
a transmitting section that transmits downlink control information (DCI), wherein
when one piece of the DCI simultaneously schedules PDSCHs respectively transmitted on a plurality of component carriers (CCs), a TCI state based on a common rule is applied to the PDSCHs.
